(19) United States
(12) Patent Application Publication
(10) Pub. No.: US 2004/0263291 A1
(43) Pub. Date: Dec. 30, 2004

(54) Waveguide interface

(75) Inventors: Bruce David Corkill, Eastbourne (NZ); Eric Resurreccion Tiongson, Daly City, CA (US); Louis Arthur Salinas, Pleasanton, CA (US)

Correspondence Address: DECHERT LLP, P.O. BOX 10004, PALO ALTO, CA, 94303, US

(73) Assignee: Stratex Networks, Inc.

(21) Appl. No.: 10/601,753

(22) Filed: Jun. 24, 2003

(51) Int. Cl. H01P 1/06

(52) U.S. Cl. 333/256

(57) ABSTRACT

A method of coupling together first and second waveguide connectors. The method including the steps of a) moving the connectors together to a first axial position in which part of the first connector engages a first axial stop on the second connector; b) causing relative movement between the first connector and the first axial stop; and c) moving the interface assemblies together axially after step b) to a second axial position in which part of the first connector engages a second axial stop on the second connector. Each waveguide connector includes a waveguide aperture; and one or more screw assemblies including a screw and captive nut. The waveguide connectors include a plug and socket connection with an elliptical profile. One of the connectors has a curved slot with two or more counterbores formed around the slot, and a securing member received in a first one of the counterbores. The polarization direction of the connector is changed by a) removing the securing member from the first one of the counterbores; b) rotating the waveguide interface until the securing member is aligned with a second end one of the counterbores; and c) inserting the securing member into the second one of the counterbores.

### FIELD OF THE INVENTION

The present invention relates to various methods and apparatus for use in aligning and connecting together a pair of waveguides. The invention also relates to a method of adjusting the orientation of a waveguide interface. The waveguide joint is typically, although not exclusively, positioned between a radio and an antenna.

### OBJECTS OF THE INVENTION

A first object of the invention is to provide a method of coupling waveguide connectors together which reduces the chance of damaging one or both of the connectors.

A further object of the invention is to provide a waveguide interface assembly with a screw assembly which is suitable for use at an elevated position, for instance at the top of a mast.

A further object of the invention is to provide a waveguide interface which can be easily aligned with another interface to form a joint.

A further object of the invention is to provide an improved method of adjusting the orientation of a waveguide interface, in which the waveguide interface can be aligned accurately in a desired orientation.

### BRIEF DESCRIPTION OF PREFERRED EMBODIMENT

A first aspect of the preferred embodiment provides a method of coupling together first and second waveguide connectors, the method including the steps of a) moving the connectors together to a first axial position in which part of the first connector engages a first axial stop on the second connector; b) causing relative movement between the first connector and the first axial stop; and c) moving the interface assemblies together axially after step b) to a second axial position in which part of the first connector engages a second axial stop on the second connector.

The use of first and second axial stops reduces the chance of damage between the connectors.

Preferably the relative movement between the first connector and the first axial stop in step b) causes the first and second waveguide connectors to become captive. This enables an installer to take their hands off the connector assembly when the connectors become captive.

The relative movement in step b) may be achieved by moving the first connector or by moving the first axial stop.

A further aspect of the preferred embodiment provides a waveguide connector for connection with a second waveguide connector to form an axially extending waveguide joint, the connector including a first axial stop at a first axial position; and a second axial stop at a second axial position. The first and second waveguide connectors may be provided separately, in an assembled state, or as a kit of parts.

A further aspect of the preferred embodiment provides a waveguide connector including a waveguide aperture; and one or more screw assemblies, each screw assembly including:

a screw with a head and a threaded shaft screwed into a threaded bore in the waveguide connector; and

a captive nut threaded onto the shaft and positioned between the head of the screw and the waveguide connector.

The nut is “captive” between the head of the screw and the waveguide connector. Thus it is difficult or impossible for an operator to accidentally unscrew the nut from the screw. This makes the connector particularly suited for use in an elevated location, for instance at the top of a mast, where the nut could fall to the ground if it is unscrewed by accident.

A further aspect of the preferred embodiment provides a waveguide connector kit including a plug having a distal end with a waveguide aperture formed therein, the plug having a side wall with a non-circular profile; and a socket for receiving the plug, the socket having a base with a waveguide aperture formed therein, and a side wall having a non-circular profile which mates with the non-circular profile of the plug when the plug and socket are brought together in correct alignment.

By providing a non-circular profile, the plug and socket can be aligned easily. The plug and socket may be provided separately, or as a kit of parts.

A further aspect of the preferred embodiment provides a method of adjusting the orientation of a waveguide interface, the waveguide interface including a waveguide aperture, a curved slot with two or more counterbores formed around the slot, and a securing member received in a first one of the counterbores, the method including the steps of a) removing the securing member from the first one of the counterbores; b) rotating the waveguide interface until the securing member is aligned with a second end one of the counterbores; and c) inserting the securing member into the second one of the counterbores.

This aspect enables the waveguide interface to be aligned accurately in accordance with the positions of the counterbores.

### BRIEF DESCRIPTION OF THE DRAWINGS

Illustrative embodiments of the invention will now be described with reference to the accompanying drawings to disclose the advantageous teachings of the present invention.

FIG. 1 is a schematic view of a cellular phone network;

FIG. 2 is a perspective exploded view of a point-to-point station with an antenna waveguide interface in its horizontal orientation;

FIG. 3 is a perspective view of a radio;

FIG. 4 is a perspective view of a screw assembly;

FIG. 5 is a sectional view of an antenna, antenna waveguide interface, antenna mount and antenna mounting ring;

FIG. 6 is a side view of the antenna waveguide interface;

FIG. 7 is a perspective view of the antenna waveguide assembly;

FIG. 8 is a rear view of the antenna waveguide interface;

FIG. 9 is a rear view of the antenna mounting ring

FIG. 10 is a section taken along line F-F in FIG. 9;

FIG. 11 is a section taken along line E-E in FIG. 9;

FIG. 12 is a front view of the antenna mounting ring; and

FIG. 13 is a perspective view showing the antenna waveguide in its vertical orientation.

### DETAILED DESCRIPTION OF EMBODIMENT OF THE INVENTION

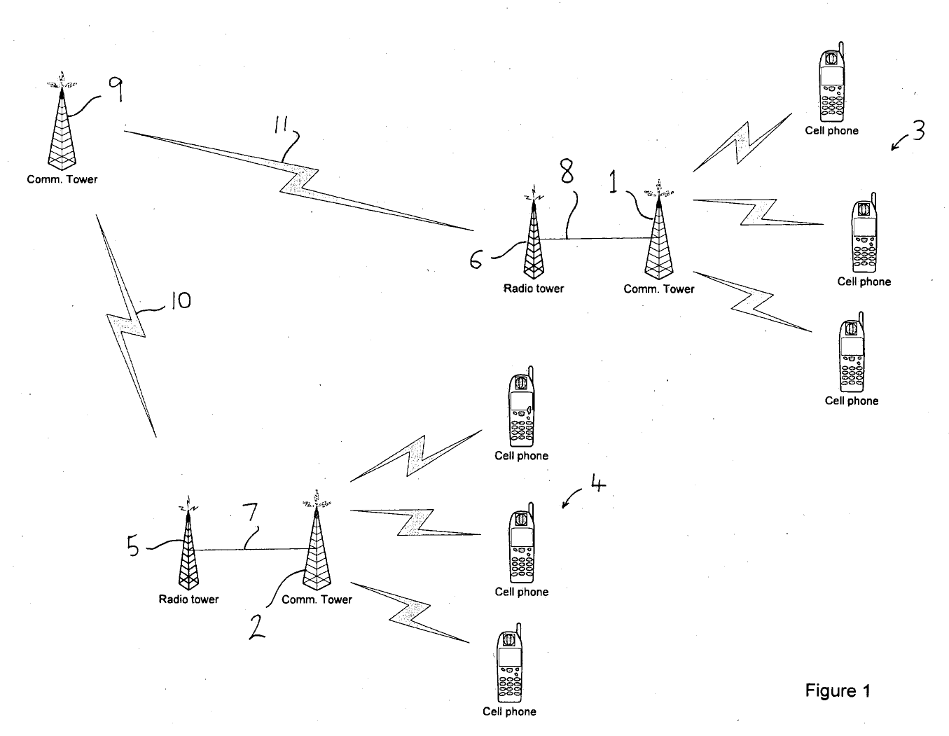

A cellular phone network is shown in FIG. 1. Base stations 1,2 perform full duplex communication with a number of cell phones 3,4 registered in a cell. The base stations 1,2 are coupled to respective point-to-point stations 5,6 via cables 7,8. Stations 5,6 communicate with a main exchange 9 via point-to-point microwave links 10,11.

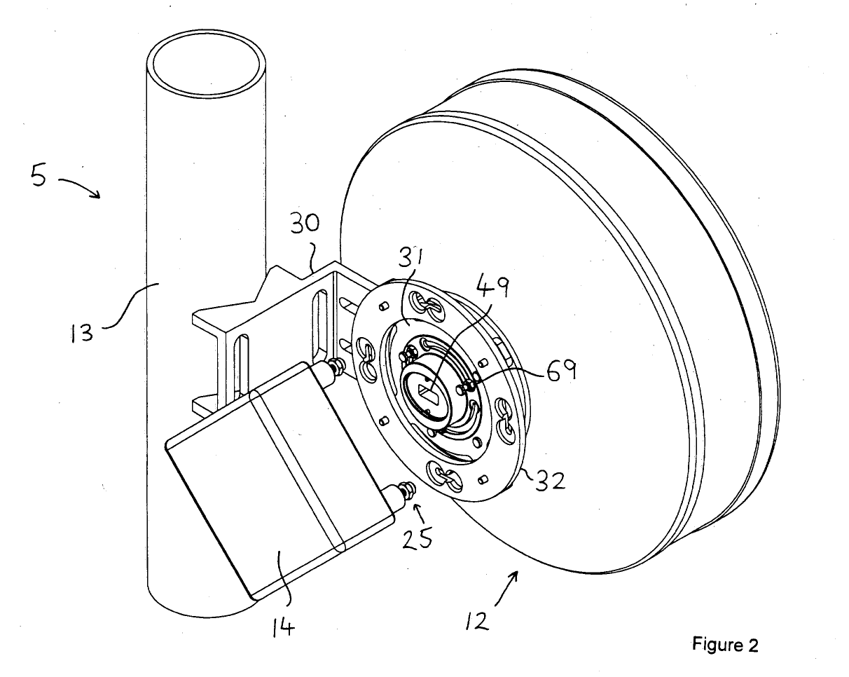

One of the point-to-point stations 5 is shown in FIG. 2. The main components are an antenna 12, mast 13 and radio 14. The radio 14 is coupled to cable 7 (shown in FIG. 1) and performs a number of signal processing functions such as amplification, modulation, demodulation, filtering etc.

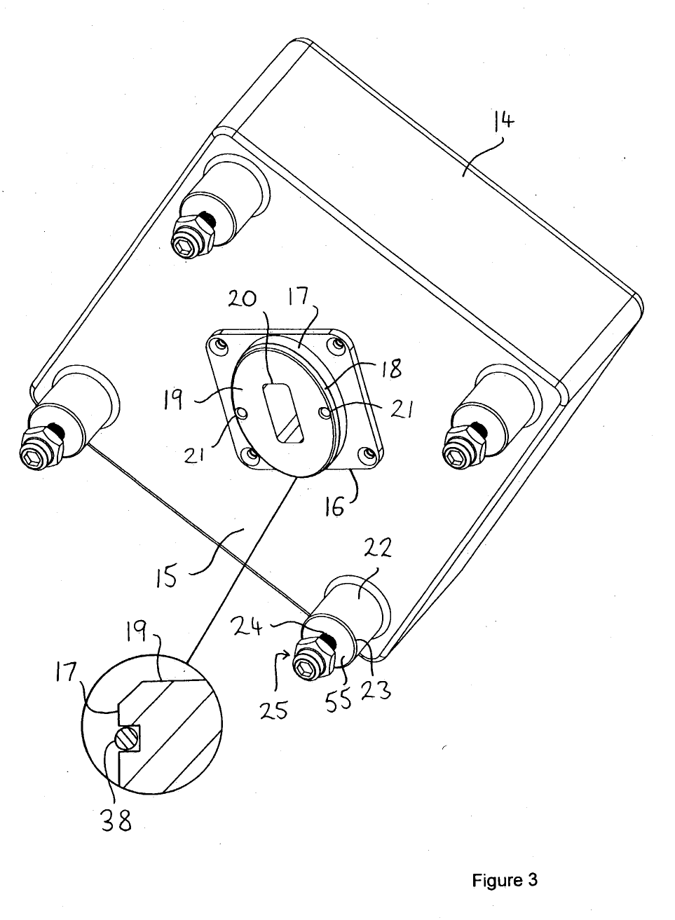

The radio 14 is shown in detail in FIG. 3. The radio 14 includes a housing with a front face 15 which supports a radio waveguide interface. The waveguide interface includes a square outer flange 16 with four bores (not labeled) which receive screws (not shown) for attaching the radio waveguide interface to the front face 15. An elliptical projecting hub has side walls 17, chamfered edge 18 and planar face 19. The face 19 has a rectangular waveguide aperture 20 and a pair of bores 21 on opposite sides of the aperture 20. The bores 21 have chamfered edges (not labeled). An O-ring 38 is mounted in a groove running round the side walls 17.

In an alternative embodiment (not shown) the radio waveguide interface could be part of the housing. For example the housing could have the waveguide aperture machined into it so that the housing and waveguide are a single piece.

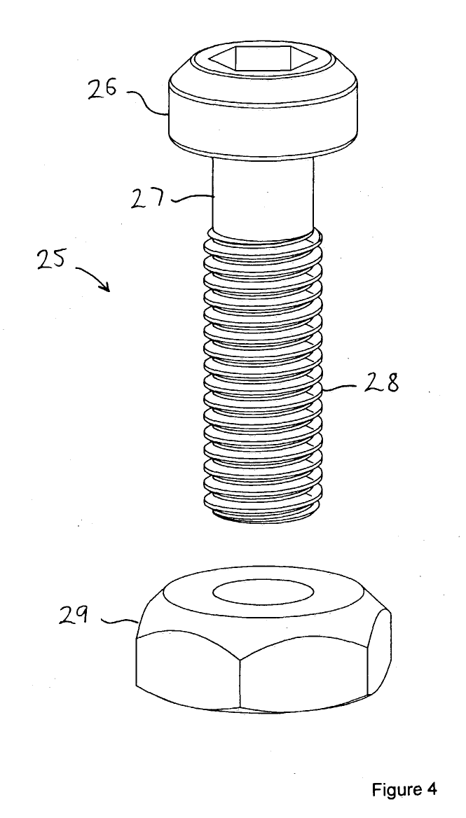

The front face 15 of the radio housing also carries four identical mounting assemblies, one at each corner. Each assembly includes a base with cylindrical walls 22, chamfered edge 23 and front face 55 with an internally threaded bore 24. A screw assembly 25 is threaded into the bore 24, and is shown in detail in FIG. 4. The assembly 25 includes a screw with a head 26, a shaft with an unthreaded proximal portion 27 and a threaded distal portion 28; and a captive nut 29. The diameter of the unthreaded portion 27 is less than the diameter of the threaded portion 28. Therefore the nut 29 can be screwed onto the shaft along the threaded portion 28 until it reaches the unthreaded portion 27, at which point the nut 29 becomes “free wheeling”. The unthreaded portion 27 prevents an installer from screwing the nut 29 any further, which could cause the assembly 25 to unscrew from the bore 24.

Referring to FIG. 5, the antenna 12 includes a parabolic reflector 33, mounting flange 36, radome 34, and an antenna horn (not shown) which transmits/receives radiation to/from the reflector 33 and couples the energy into rectangular waveguide 35. An antenna mount 31 is screwed to the mounting flange 36, to an antenna mounting ring 32, and to a pole mount 30 which connects the antenna 12 to the mast 13 (as shown in FIG. 2).

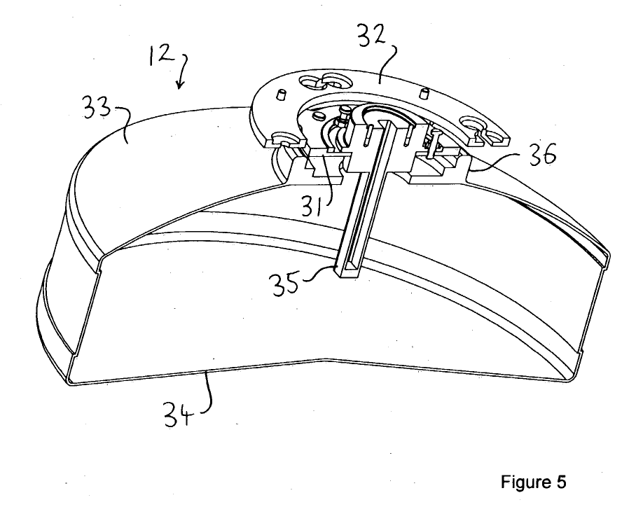

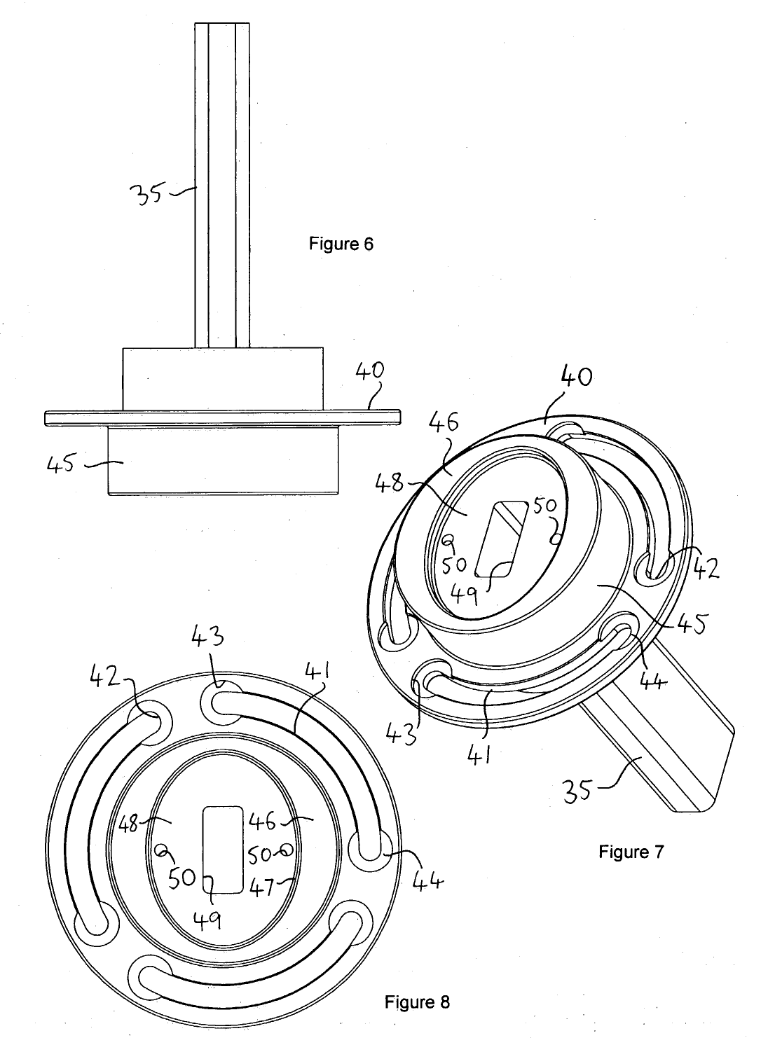

The waveguide 35 is terminated by an antenna waveguide interface shown in detail in FIGS. 6-8. The antenna waveguide interface includes a circular outer flange 40 with three curved slots 41, each having a pair of ends 42. The rear face of the outer flange 40 is formed with six circular counterbores 43, each positioned at a respective end 42 of a slot 41. The assembly also has a cylindrical hub with side walls 45, and a planar face 46. An elliptical recess is formed in the face 46, and has side walls 47 and a planar base 48. The walls 47 and base 48 meet at a chamfered edge (not labeled) and the walls 47 and face 46 also meet at a chamfered edge (not labeled). A rectangular waveguide aperture 49 is formed in the base, along with a pair of bores 50 on opposite sides of the aperture 49. The bores 50 receive dowel pins (not shown in FIGS. 7-8, but shown in FIG. 2).

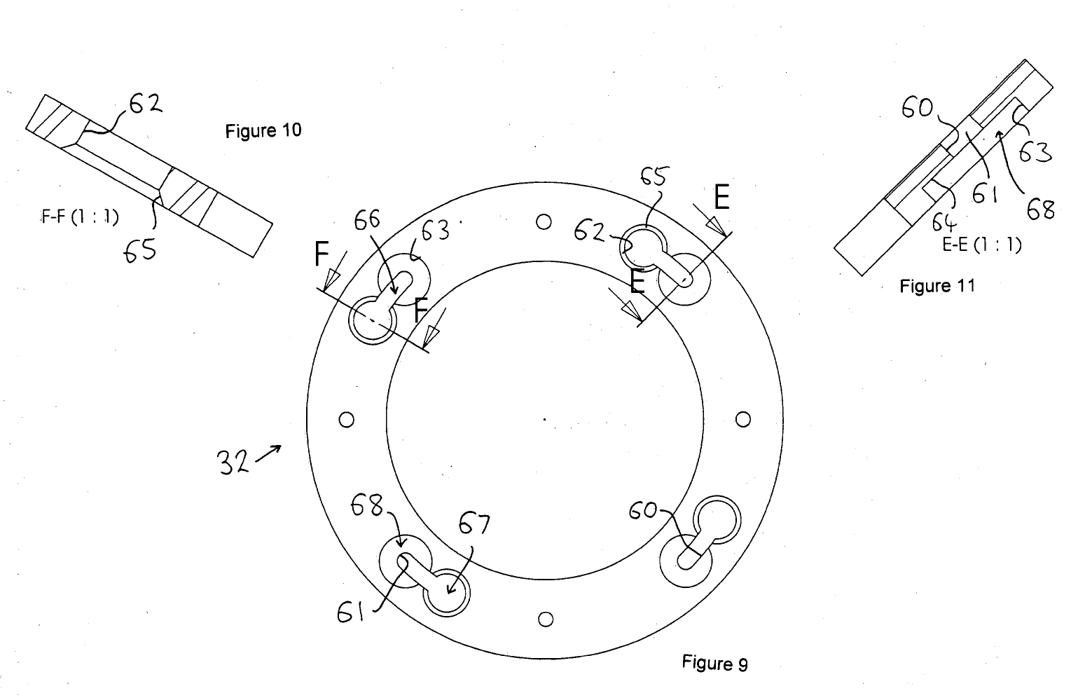

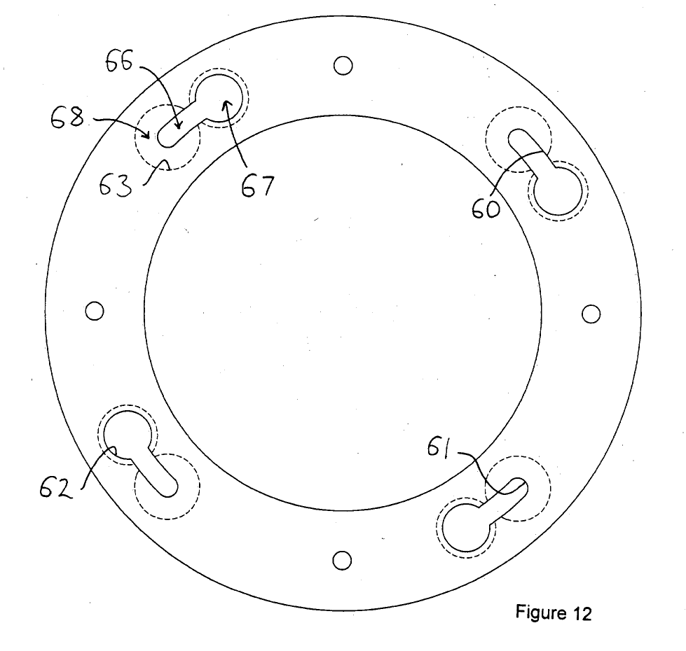

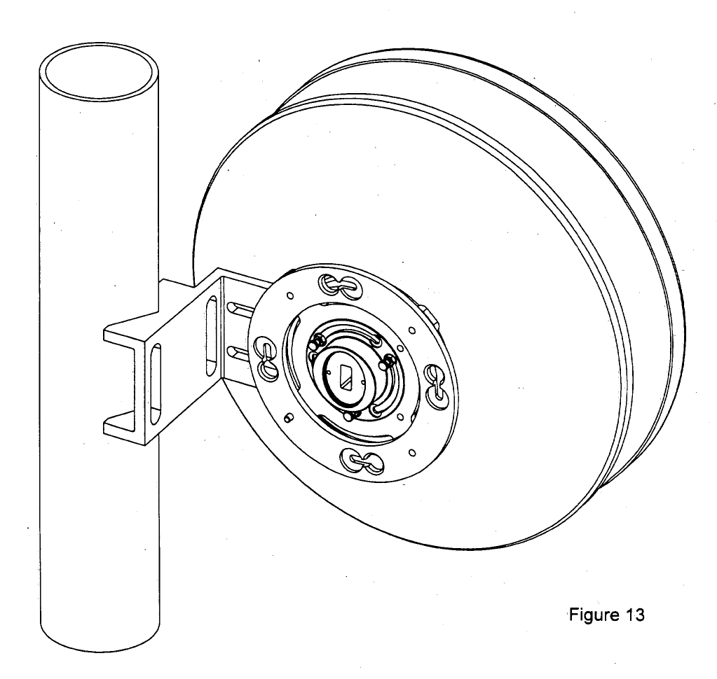

The antenna mounting ring 32 is shown in detail in FIGS. 9-12. The ring is formed with four “keyhole” shaped slots. Each slot has an elongate portion 66 with side walls 60 and an end 61. The end 61 of the slot acts as a transverse rotary stop, as described in further detail below. The elongate portion 66 opens up into a circular portion 67 with side walls 62 and chamfered edge 65. The rear face of the ring is formed with a circular counterbore 68 with side walls 63 and base 64, positioned at each end 61 of the elongate portion of each slot.

Returning to FIG. 2, the antenna 12 and radio 14 are installed using the following steps:

1. Mount antenna on mast 13 with waveguide in desired orientation (vertical or horizontal).

2. Rotate radio 14 into correct orientation (with aperture 20 aligned with aperture 49).

3. Insert head 26 of screw and nut 29 through circular portion 67 of slot in antenna mounting ring 32, until front face 55 of base of mounting assembly engages the rear face of the mounting ring (which acts as a first axial stop). Note that the diameter of the circular portion 67 is greater than the diameter of the head 26 of the screw and the nut 29, thus allowing them to pass through. However, the diameter of the circular portion 67 is less than the diameter of the face 55, thus preventing the face 55 from passing through the slot.

4. Rotate radio 17 so shaft of screw assembly 25 is guided along elongate portion 66 of slot. Note that as soon as the shaft enters the elongate portion 66 of the slot, the radio becomes captive. The radio is rotated until it engages end 61 of the slot (which acts as a transverse rotary stop).

5. At this point, the antenna waveguide is precisely aligned with the radio waveguide. Note that the diameter of the counterbore 68 is greater than the diameter of the front face 55. Thus the radio 14 can now be translated axially to a second axial position in which the planar face 19 of the radio waveguide interface engages the planar base 48 of the antenna waveguide interface (which acts as a second axial stop). Note that the surfaces 19,48 are machined to be precisely planar so as to ensure accurate alignment of the waveguides. A small clearance is provided at this second axial position between the face 55 and the base 64 of the counterbore 68. The O-ring 38 seals against the side walls 47 of the recess. In a first alternative embodiment, the base 64 of the counterbore 68 may act as the second axial stop by engaging the face 55. In this case, a small clearance may be left between the elliptical faces 19,48. In a third alternative embodiment, if precise machining of the parts can be achieved, then parts 64 and 48 can both act simultaneously as axial stops in the second axial position (that is, base 64 engages face 55, and face 19 engages face 48).

6. Secure the radio 14 in place by tightening each nut 29 against the front face of the antenna mounting ring 32.

If the waveguide interfaces could be brought together without being precisely in alignment, then the dowel pins would engage the face 19 instead of being received in the bores 21. This could cause damage to the dowel pins and/or the face 19. The mounting method described above reduces the chance of such damage by ensuring accurate alignment.

It should be noted that the waveguide interfaces described above have two sets of mating parts. That is, the dowel pins and bores 21 are a first set of mating parts, and the plug and socket formed by elliptical side walls 17, 47 are a second set of mating parts. In an alternative embodiment (not shown), only the first or second set of mating parts may be necessary. Thus for instance the dowel pin may be used, but the side walls 17, 47 may be circular. Alternatively, the elliptical side walls 17, 47 may be retained, and the dowel pins omitted. Instead of having an elliptical shape, the side walls 17, 47 may have an alternative non-circular shape (for instance, oval, square or rectangular). However, preferably the shape is a continuously curved shape (such as oval or elliptical) to enable the O-ring 38 to be easily fitted.

The coupling between the antenna waveguide interface and the antenna mount 31 is designed to allow the polarization orientation of the antenna to be changed, as described below. Referring to FIG. 2 (which shows the aperture 49 in a horizontal orientation) the antenna waveguide interface is mounted onto the antenna mount 31 by three screw assemblies 69. The screw assemblies 69 are identical in construction to the screw assembly 25 shown in FIG. 4. Each assembly 69 passes through a respective slot in the antenna waveguide interface, and is screwed into an internally threaded bore (not shown) in the antenna mount 31. The nut is then screwed along the threaded shaft until it engages the base 44 of the circular counterbore 43 at the end of the slot.

The polarization can then be changed by the following steps:

1. Remove the radio 14.

2. Unscrew the nut of each screw assembly 69.

3. Rotate the antenna waveguide interface until the other end 42 of each slot engages the screw assembly 69. At this point the aperture 49 will have rotated by precisely 90 degrees. See FIG. 13 which shows the antenna waveguide interface in its vertical orientation. The antenna horn (not shown) is connected to the waveguide 35 so that it also rotates with the antenna waveguide interface.

4. Tighten the three nuts.

5. Mount the radio 14 with the aperture 20 in the correct alignment.

The circular counterbore 43 at the end of each slot ensures that the antenna waveguide interface is secured in precise vertical or horizontal alignment.

In an alternative embodiment (not shown), the mounting ring may be rotatably mounted to the antenna waveguide interface. After the waveguide interfaces have moved together to the first axial position, the mounting ring is rotated until the shaft of the screw engages the other end of the slot. The waveguide interfaces can then brought together to the second axial position. Thus in this embodiment the relative movement between the radio and the mounting ring is achieved by rotating the mounting ring, instead of rotating the radio.

In a further alternative the slots 66 may be straight, instead of curved. In this case, there will be a translational movement between the two positions, instead of a rotational movement.

In yet a further alternative, the three slots 41 in the antenna waveguide interface may be replaced by a single annular slot with six counterbores at the same positions as the counterbores 43.

The present invention has been described herein with reference to particular embodiments for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. A method of coupling together first and second waveguide connectors, the method including the steps of a) moving the connectors together to a first axial position in which part of the first connector engages a first axial stop on the second connector; b) causing relative movement between the first connector and the first axial stop; and c) moving the interface assemblies together axially after step b) to a second axial position in which part of the first connector engages a second axial stop on the second connector.

2. A method according to claim 1 wherein the relative movement between the first connector and the first axial stop in step b) causes the first and second waveguide connectors to become captive.

3. A method according to claim 1 wherein the movement in step b) is a rotary movement.

4. A method according to claim 1 wherein the first connector is moved in step b).

5. A method according to claim 1 wherein part of the first connector engages a transverse stop on the second connector at the end of step b) and before step c)

6. A method according to claim 1 including the step of aligning male and female parts of the first and second connectors before step a), and mating the male and female parts together during step a).

7. A method according to claim 1 including the step of aligning male and female parts of the first and second connectors before step c), and mating the male and female parts together during step c).

8. A method according to claim 1 including the steps of aligning first male and female parts of the first and second connectors before step a), mating the first male and female parts together during step a); aligning second male and female parts of the first and second connectors before step c), and mating the second male and female parts together during step c).

9. A waveguide connector for connection with a second waveguide connector to form an axially extending waveguide joint, the connector including a first axial stop at a first axial position; and a second axial stop at a second axial position.

10. A waveguide connector according to claim 9 including a female part for receiving a mating male part of the second waveguide connector.

11. A waveguide connector according to claim 10 wherein the female part is an elongate slot.

12. A waveguide connector according to claim 11 wherein the elongate slot has a relatively wide portion and a relatively narrow portion.

13. A waveguide connector according to claim 12 wherein the slot has a counterbore formed around the relatively narrow portion of the slot.

14. A waveguide connector according to claim 12 wherein the relatively wide portion of the slot is substantially circular.

15. A waveguide connector according to claim 12 wherein the relatively narrow portion of the slot is elongate.

16. A waveguide connector according to claim 12 wherein the relatively narrow portion of the slot is curved.

17. A waveguide connector according to claim 11 wherein the slot is a closed slot.

18. A waveguide connector according to claim 11 including two or more elongate slots.

19. A waveguide connector according to claim 9 including a waveguide aperture.

20. A waveguide connector including a waveguide aperture; and one or more screw assemblies, each screw assembly including:
a. a screw with a head and a threaded shaft screwed into a threaded bore in the waveguide connector; and
b. a captive nut threaded onto the shaft and positioned between the head of the screw and the waveguide connector.

21. A waveguide connector according to claim 20 wherein the shaft has a threaded distal portion and an unthreaded proximal portion.

22. A waveguide connector according to claim 21 wherein the unthreaded proximal portion is adjacent to the head of the screw.

23. A waveguide connector according to claim 20, mounted in use at an elevated location on a mast.

24. A waveguide assembly including a waveguide connector according to claim 20, and a mounting member for mounting the waveguide assembly in use on a mast.

25. A waveguide connector kit including a plug having a distal end with a waveguide aperture formed therein, the plug having a side wall with a non-circular profile; and a socket for receiving the plug, the socket having a base with a waveguide aperture formed therein, and a side wall having a non-circular profile which mates with the non-circular profile of the plug when the plug and socket are brought together in correct alignment.

26. A connector for use in an assembly according to claim 25, including a plug having a distal end with a waveguide aperture formed therein, the plug having a side wall with a non-circular profile.

27. A connector according to claim 26 wherein the profile is continuously curved.

28. A connector according to claim 26 wherein the side wall has a groove formed therein for receiving an O-ring.

29. A connector according to claim 26 further including a chamfered edge between the distal end of the plug and the side wall.

30. A waveguide connector for use in an assembly according to claim 25, including a socket having a base with a waveguide aperture formed therein, and a side wall having a non-circular profile.

31. A connector according to claim 30 wherein the profile is continuously curved.

32. A connector according to claim 30 further including a chamfered edge between the base of the socket and the side wall.

33. A waveguide interface having a waveguide aperture; one or more curved slots; and two or more counterbores formed around the slot.

34. A waveguide interface according to claim 33 wherein each counterbore is substantially flat bottomed.

35. A waveguide interface according to claim 33 wherein each counterbore is substantially circular.

36. A waveguide interface according to claim 33 wherein the or each slot has a first end and a second end; a first counterbore formed around the first end of the slot; and a second counterbore formed around the second end of the slot.

37. A waveguide interface according to claim 33 having two or more slots, each slot having two or more counterbores formed around the slot.

38. A waveguide interface according to claim 33 including a flange surrounding the waveguide aperture, wherein the slots are formed in the flange.

39. A method of adjusting the orientation of a waveguide interface, the waveguide interface including a waveguide aperture, a curved slot with two or more counterbores formed around the slot, and a securing member received in a first one of the counterbores, the method including the steps of a) removing the securing member from the first one of the counterbores; b) rotating the waveguide interface until the securing member is aligned with a second end one of the counterbores; and c) inserting the securing member into the second one of the counterbores.

40. A method according to claim 39 wherein step b) includes rotating the waveguide interface until the securing member engages an end of the slot.

41. A method according to claim 39 wherein the waveguide interface is coupled to an antenna whereby the antenna rotates with the waveguide interface during step b).
